(19) United States
(12) Patent Application Publication
(10) Pub. No.: US 2009/0144113 A1
(43) Pub. Date: Jun. 4, 2009

(54) SYSTEM AND METHOD FOR ASSISTING IN THE FINANCIAL MANAGEMENT OF PHYSICIAN PRACTICES

(76) Inventors: James D. Hamilton, Spencerville, IN (US); Regina Elkins, Johnstown, OH (US)

Correspondence Address: BARNES & THORNBURG LLP, 600 ONE SUMMIT SQUARE, FORT WAYNE, IN, 46802, US

(21) Appl. No.: 12/327,069

(22) Filed: Dec. 3, 2008

Related U.S. Application Data
(60) Provisional application No. 60/991,885, filed on Dec. 3, 2007.

(51) Int. Cl. G06Q 10/00

(52) U.S. Cl. 705/7

(57) ABSTRACT

A computerized system and method for financial management of physician practices. In some embodiments, there are decision support tools to assist users in specified areas for physician practice, financial, and operational improvement. The decision support tools could provide help screens that provide assistance specific to financial reports or financial tools being viewed by the user. The decision support tools could be associated with a variety of financial tools and reports, including but not limited to monthly reports, year-to-date reports, benchmark tools, financial ratio reports, revenue cycle reports, Current Procedural Terminology (“CPT”) coding histograms/financial tables, and fee analyzer reporting tools.

### RELATED APPLICATION

This application claims priority to U.S. Provisional Application No. 60/991,885, filed Dec. 3, 2007, the entire disclosure of which is hereby incorporated by reference.

### TECHNICAL FIELD

This invention relates generally to computerized decision support tools that assist in the financial management of physicians' practices.

### BACKGROUND

The environment for the business of medicine has been bifurcated. On one side has been the physician driven independent practice of medicine, while on the other the acute care hospital delivery of care. In part, the hospital has been viewed as the work shop for the physicians wherein some portion of the physician's professional trade has been conducted. The remainder of the physician's trade has been conducted in the physician office environment. As the downward economic pressure continues for the business of medicine, this will inevitably force stronger partnerships between physicians and hospitals. One method of partnership will be through the direct employment of physicians by hospitals. What will also be seen is the continued self employment of physicians, most likely in a consolidated environment of group practice. The economic understanding and management of the private physician practice and the hospital are starkly different. What is seen in today's market is the need for a common language and understanding of benchmarked financial reporting for both of these environments.

In light of this environment, the use of financial reporting tools to conduct the business of medicine is essential. Hospitals, as well as medical practices, have been provided common guidance in the logic and format of financial reporting. This has been refined through general accounting principles and industry specific recommendations. In general, the sophistication of financial reporting in the hospital environment is greater than that found in the physician's private practice. In hospital financial reports, accrual accounting is the standard for reporting, while the standard for physician practices has historically been cash or modified cash basis of reporting. In the general mainstream of reporting there is the usual monthly and year-to-date reporting with comparison to budget performance. For the physician practice environment there has been financial reporting based on performance to benchmark. The source of this benchmark information has included data from varying professional specialty organizations or the Medical Group Management Association (“MGMA”). In addition, the reporting tools for Current Procedural Terminology coding, revenue cycle performance, and fee analyzers have been very limited in use. In part, this is due to inadequate tools being available to the end user.

Another important factor that needs consideration is the current lack of management staff that has adequate knowledge and experience of understanding the sophistication of the financial reporting within these environments. Therefore, there exists a need for tools for assisting a decision maker in determining how to achieve financial and operational improvement of physician practices in this environment.

### SUMMARY

According to one aspect, the present invention provides decision support tools to assist users in specified areas for physician practice, financial, and operational improvement. For example, the decision support tools could be help screens that provide assistance specific to financial reports or financial tools being viewed by the user. The decision support tools could be associated with a variety of financial tools and reports, including but not limited to monthly reports, year-to-date reports, benchmark tools, financial ratio reports, revenue cycle reports, Current Procedural Terminology (“CPT”) coding histograms/financial tables, and fee analyzer reporting tools. The financial management reports and associated decision support tools could be used in the private practice of medicine, as well as for physicians that are employed in hospitals or health systems. The decision support tools could be provided for a variety of medical specialties.

According to another aspect, the invention provides a computerized financial management system for physician practices. The system provides a computing device configured to generate a request for a plurality of parameters indicative of a physician practices' financial condition. An application server is included that receives the request from the computing device via a communications network and sends a response that includes the parameters requested by the computing device and an identification of one or more missed parameters that fall outside a predetermined benchmark. Typically, the computing device is configured to query the application server for at least one possible reason why one or more of the missed parameters fell outside the predetermined benchmark. The application server is configured to receive the query and send a response that includes one or more possible causes why the missed parameters fell outside the predetermined benchmark. Embodiments are contemplated in which the computing device is configured to generate a request for one or more of a monthly report, a year-to-date report, a benchmark report, a financial ratio report, a revenue cycle report, a CPT coding report, and a fee analyzer report. In some cases, the application server could be configured to include possible corrective action to be taken to correct one or more missed parameters. For example, the application server could include a plurality of parameters indicative of a physician practices' financial condition that can be reported to the computing device that have a predetermined range of acceptable values. Each of the parameters could be associated with one or more predetermined possible reasons why a respective parameter is outside the range of acceptable values.

According to a further aspect, the invention provides a computerized method for financial management of a physician's practice. The method may include the step of presenting a computerized analysis tool configured to report one or more parameters regarding financial management of physician practices. A request may be received for a financial report or financial analysis. A determination may be made whether any parameters in the financial report or financial analysis are outside a predetermined benchmark. In response to a request for guidance regarding a parameter that is outside the benchmark, one or more possible causes for missing the benchmark could be automatically generated.

According to another aspect, the invention provides a system for financial management of a physicians' practice. In this embodiment, the system may include a financial reporting/analysis module configured to provide a plurality of parameters in at least one of a financial report and financial analysis of a physician's practice. Typically, at least one parameter is outside a benchmark. The system may also include one or more decision support tools configured to generate possible causes why the parameter is outside the benchmark.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is an example financial management system for physician practices according to an embodiment of the invention;

FIG. 2 is a flow chart showing example steps that may be performed during the operation of the system shown in FIG. 1; and

FIGS. 3-7 are example screen shots that may be associated with the decision support tools of the system.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will be described in detail herein. It should be understood, however, that there is no intent to limit the concepts of the present disclosure to the particular forms disclosed; but on the contrary, the intention is to cover all modifications, equivalents, and alternatives falling within the spirit and scope of the disclosure.

FIG. 1 shows a financial management system for physician practices 100 according to an illustrative embodiment. As shown, the system 100 includes a financial reporting/analysis module 102 that is configured to provide reports and analysis regarding a variety of parameters that affect the financial and operational well being of a physician's practice, including but not limited to monthly reports, year-to-date reports, benchmark tools, financial ratio reports, revenue cycle reports, Current Procedural Terminology (“CPT”) coding histograms/financial tables, and fee analyzer reporting tools. In the example shown, the financial reporting/analysis module 102 includes income statement and statistical data 104, provider coding graphs and histograms 106, revenue cycle performance reports 108, and fee analyzer reports 110. It should be appreciated, however, that other types of reports and analysis tools could be included in the financial reporting/analysis module 102. The system 100 includes decision support tools 112 that are configured to assist in providing possible causes for any parameters that fall outside of predetermined benchmarks. This assists users that may not have adequate experience and/or understanding of the financial reports, which leads to improved financial and operational performance.

As should be appreciated by one skilled in the art, the system 100 may be embodied in many different forms, such as one or more devices, methods, data processing systems, or program products. Accordingly, embodiments of the invention may take the form of an entirely software embodiment or an embodiment combining hardware and software aspects. Furthermore, embodiments of the invention may take the form of a computer program product on a computer-readable storage medium having computer-readable program code embodied in the storage medium. Any suitable storage medium may be utilized, including read-only memory (“ROM”), RAM, DRAM, SDRAM, hard disk, CD-ROMs, DVD-ROMs, any optical storage device, and any magnetic storage device.

Although the system 100 is represented by a single computing device in FIG. 1, the operation of the system 100 may be distributed among a plurality of computing devices. For example, it should be appreciated that various subsystems (or portions of subsystems) may operate on different computing devices. In some such embodiments, the various subsystems of the system 100 may communicate over a network.

In some cases, the system 100 may be stored and executed locally on a computing device 114. Embodiments are also contemplated in which the system 100 could communicate with one or more computing devices through a network. The network may be any type of communication scheme that allows computing devices to share and/or transfer data, including but not limited to a local area network, a wide area network, and a shared public infrastructure such as the Internet. In embodiments where some or all of the data is transmitted over the shared public infrastructure the data may be encrypted; for example, by using a secure sockets layer (“SSL”) and/or public key infrastructure (“PKI”) certificate and/or a virtual private network (“VPN”). The network may include fiber optic, wired, and/or wireless communication capability and any of a plurality of protocols, such as TCP/IP, Ethernet, WAP, IEEE 802.11, or any other protocol.

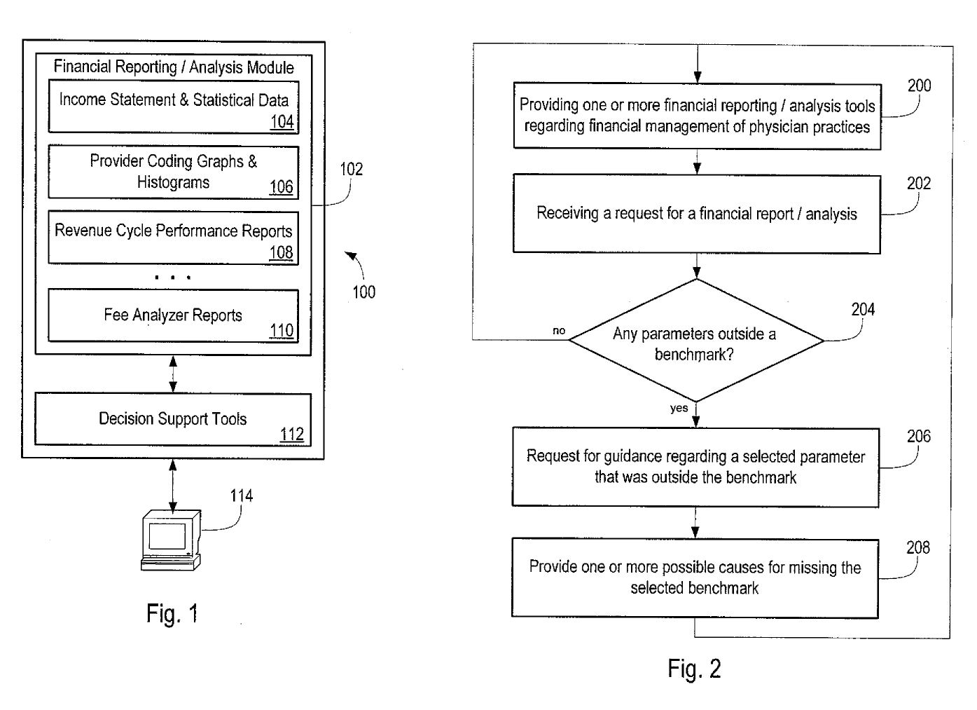

FIG. 2 shows example steps that may occur during the operation of the system 100. The user would be presented with one or more financial reporting/analysis tools regarding the financial management of physician practices (Block 200). As discussed above, this could include, but is not limited to, monthly reports, year-to-date reports, benchmark tools, financial ratio reports, revenue cycle reports, Current Procedural Terminology (“CPT”) coding histograms/financial tables, and fee analyzer reporting tools. Depending upon the particular information needed, the user would request a particular financial report and/or analysis (Block 202). Typically, the report/analysis would indicate if any parameters are outside a predetermined benchmark (Block 204). The term “outside the benchmark” encompasses both above and below a benchmark, depending on the particular benchmark. For example, revenue may be outside the benchmark by being too low, while expenses may be outside the benchmark by being too high. If none of the parameters are outside the benchmark, the user may select another financial reporting/analysis tool.

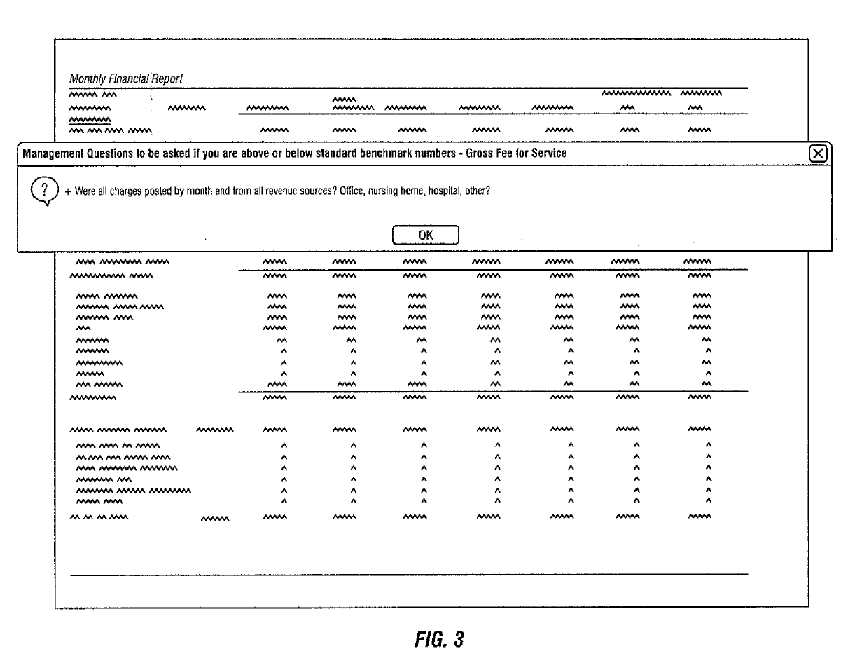

If one or more parameters are outside the benchmark, the user may request a decision support tool about the parameter to provide guidance as to why the parameter was outside the benchmark (Block 206). In some embodiments, the decision support tool may include one or more help screens that present the user with possible items to consider as impacting the selected parameter, which allows the user to investigate and possibly make adjustments to improve performance (Block 208). Consider an example in which a report showed that physician compensation was outside a benchmark. The decision support tool may ask the user whether medical professional dues were recently paid. By way of another example, the decision support tool may ask whether this was a three-pay-period month. In some cases, depending on the parameter outside the benchmark, the decision support tools could ask one or more follow up questions and/or statements. As discussed below, additional examples regarding the decision support tools are described with reference to FIGS. 3-7.

### EXAMPLE 1

### Income Statement and Statistical Data Reports

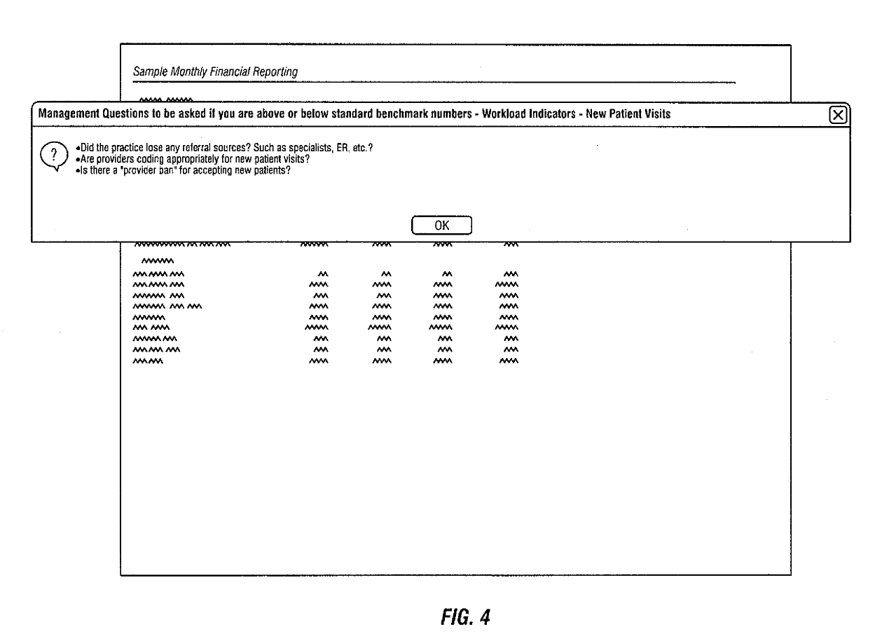

This example provides possible questions that could be asked by the decision support tools regarding parameters that may arise in the context of income statement and statistical data reports. In this example, example questions appear under the parameters in which they may be asked. FIGS. 3-4 show example help screens that could be associated with the decision support tools in this context.

### Revenue:

### Gross Fee for Service

Were any providers absent from the office for vacation, sick leave, disability or continuing medical education?

Have hospital, nursing home, or ambulatory visits declined? If so, what is the variance from the monthly average? If visits were down due to provider absence can the visits be made-up? If so, how and when will that be accomplished?

Were all charges posted by month end from all revenue sources? Office, nursing home, hospital, other?

Was there an inordinate increase in no shows and cancellations?

Was there a seasonal effect?

Were procedures down?

Is the coding index appropriate for this specialty?

### Additional Revenue

Is revenue missing that normally appears on the financial statement? Such as, sublease rental monies, etc.

### Contractual Allowances

Did the payer mix change? Was there an increase in governmental payers for the month?

Were new/different payer contracts negotiated that impacted discounts/write-offs?

Did denials increase? If so, for what reason?

Is there a new provider awaiting payer credentialing? If so, is he/she seeing only those patients for whom we can back bill?

Were all claims filed within the specified timeframe? For example, did the practice incur additional allowances due to timely filing limits?

Was there an increase in the fee schedule that resulted in an increase in contractual allowances?

Was there an increase in payment posting by the billing personnel? If so, is that reflected in the accounts receivable?

Are payers reimbursing according to the contract? If not, are the appropriate steps being taken to correct the decrease in reimbursement?

Are providers coding correctly to avoid “down coding” by the payer?

Were contractual allowance percentages increased due to anticipated increases/decreases in collections?

### Charity Allowances

Is the practice seeing an increase in the uninsured or self-pay who cannot afford to pay for healthcare?

Are the practice demographics changing? Are the market demographics changing?

Is there an increase in charity referrals? If so, what is the source(s)?

Do patients who are currently classified as charity qualify for any assistance, or additional assistance? If so, how is the practice helping to expedite that process?

Is there or should there be a cap on the percentage of the patient mix that is attributable to charity? What is the mission of the practice/hospital?

### Total Net Revenue

Conduct a MTD and YTD comparison for revenue and the MGMA standard. All questions and answers from the all potential revenue sources are applicable to Total Net Revenue.

Was there an increase in laboratory, radiology or other ancillary procedures such as ultrasounds, treadmills, physical therapy, etc?

### Expenses

### Physician Comp and Benefits

Were salaries increased due to changes in the employment agreement?

Were bonuses paid out?

Was this a three-pay-period month?

Is there a new provider? Locum Tenens?

Did benefits increase?

Were medical professional dues paid?

Did any providers attend CME offerings?

Did salaries increase due to an increase in production? If so, is this evident in net revenue?

### Midlevel Comp and Benefits

Same as above.

Was there an increase in work hours?

Did the midlevel staffing compliment change?

### Staff Comp and Benefits

Did salaries increase due to annual reviews?

Did the staffing compliment change?

Is the benefit package excessive in comparison to other practices?

What is the staffing profile and skill mix?

What is the number of staff?

Are the staff wages excessive in comparison to other practices?

Was there an increase in the utilization of temporary staffing services?

Was this a three-pay-period month?

Did the practice incur an inordinate amount of overtime?For what reason was overtime authorized?

Any one time bonuses for staff (individually or system determined)?

### Building Occupancy

Is the practice paying above market rate for leased space?

Were there leasehold improvements that increased the rent/square foot?

Was there any major building repair?

Was there an increase in taxes or insurance?

Was there an increase in utilities?

Can any portion of the building occupancy expenses qualify as a hospital overhead expense (HOH)?

Any issues in regards to depreciation?

### Clinical Supplies

Did the practice order vaccines? Such as flu vaccines, pediatric immunizations, etc?

Were medication supplies replenished?

Was there an increase in ancillary tests; therefore, an increase in testing supplies?

Was there a change in medical supply vendors?

Is the practice obligated to utilize the hospital purchasing contracts?

Was there an increase in visits due to a seasonal affect (flu) that necessitated the purchase of additional med supplies such as x-ray film, lab supplies? If so, is this reflected in visits and total net revenue?

Was new technology or services introduced in the practice?

Was there an increase in durable medical equipment such as, crutches, splints, slings, casting material, etc.?

### Purchased Services

Were practice brochures ordered/reprinted?

Did transcription services increase? If so, was there an increase in patient volume, provider “catching up” on transcription, change in vendors, increase in cost/line?

Did the practice initiate a marketing campaign?

Laundry and linen services?

Legal costs specific to the practice?

Did the practice incur charges for professional services? Test over reads? Physical therapy, etc.?

### Purchased Services—CBO

Was there an increase or decrease in collections?

Did billing costs increase/decrease due to collection?

### Equipment

Was there equipment rental/repair?

Did the practice purchase new equipment that caused an increase in depreciation?

Was there a new service offering that necessitated new equipment purchases?

Were there any technology enhancements/purchases?

### Telephone

This ratio should remain constant, except in cases where a new provider is added and there is a need to purchase a pager or cell phone.

### Other Supplies

Were additional office or cleaning supplies purchased?

### Insurance

Did malpractice insurance increase?

Is malpractice paid semi-annually or annually? If so, is the premium accrued over 12 months?

### Other Expenses

Did the practice order staff training materials?

Were any staff travel costs incurred by the practice?

Were there any business license/certificates renewed such as CLIA, etc?

### Bad Debt

Were there major A/R clean-up efforts?

Were several large balances forwarded to the collection agency?

How often is bad debt worked?

### Workload Indicators

### New Patient Visits

Did the practice lose any referral sources (such as specialists, ER, etc.)?

Are providers coding appropriately for new patient visits?

Is there a “provider ban” for accepting new patients?

Do all provider schedules have appointment times allotted for new patients on a daily basis?

Are new physicians active in increasing their patient base?

### Ambulatory Visits

Does the practice often cancel patients on the “spur of the moment”?

Has the no-show/cancellation rate increased?

Is this a seasonal affect? Normal for this time of year?

Do providers limit the time slots available for patient scheduling?

How much control does the scheduling staff exercise over the provider schedules?

What is the rate of requests for a transfer of medical records? Is there a mechanism to ascertain why patients are transferring records?

Have patient complaints increased?

Are the hours of operation conducive to the patient base?

Did competition penetrate the market?

Were any providers absent from the practice for vacation, sick, disability, continuing medical education, etc?

### Hospital and Other Visits

Is the practice utilizing the services of a hospitalist? If so, have office visits increased to offset the loss of hospital visit revenue?

Practice demographics are not conducive to hospital admissions. Young, healthy patient demographics.

Do providers make nursing home rounds?

### Total Visits

If you answered the questions regarding New Patient, Ambulatory and Hospital and Other Visits from above you have answered the questions for this section.

### Work RVU's

Were all visits coded and charges entered?

Is there a provider holding fee tickets? Missing fee tickets?

Is the coding index appropriate for the practice specialty?

Was there a change in patient acuity?

Was there an increase in patient visits?

Was there an increase in procedures?

### Coding Index

Same as above.

### EXAMPLE 2

### Provider Coding Graphs and Histograms

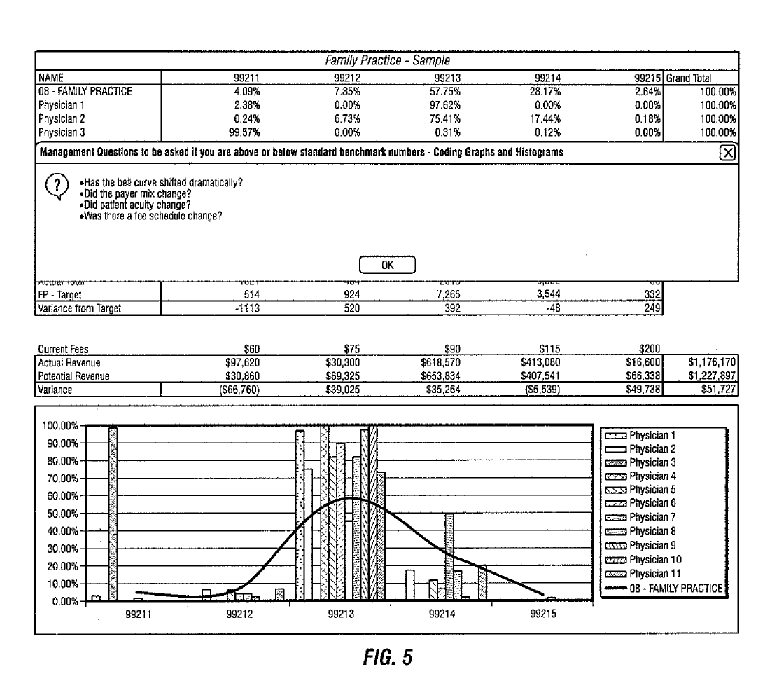

The purpose of the Provider Coding Graphs and Histograms is to deliver tools that support provider coding and documentation. In this context, the decision support tools may establish a process to measure, assess, and improve the quality of the medical record documentation and support the level of service for claims submitted to the insurance carrier. In addition, the decision support tools may provide a vehicle that promotes provider feedback and communication as it relates to current coding and documentation within a medical practice. Below are example questions that the decision support tools may raise in this context, depending on the particular parameter(s) that are outside the benchmark. FIG. 5 shows an example help screen that could be associated with the decision support tools in this context.
Has the bell curve shifted dramatically?
Did the payer mix change?
Did patient acuity change?
Was there a fee schedule change?
Were all charges submitted on behalf of the provider?
Is there a transcription lag?
Are there any missing charges? Were all charges submitted for the month?
Were all front end errors corrected in a timely manner and resubmitted?
Is the provider behind in documentation?
Has the provider coding patterns changed? If so, should a formal coding and documentation review be requested?

### EXAMPLE 3

### Revenue Cycle Performance Indicator

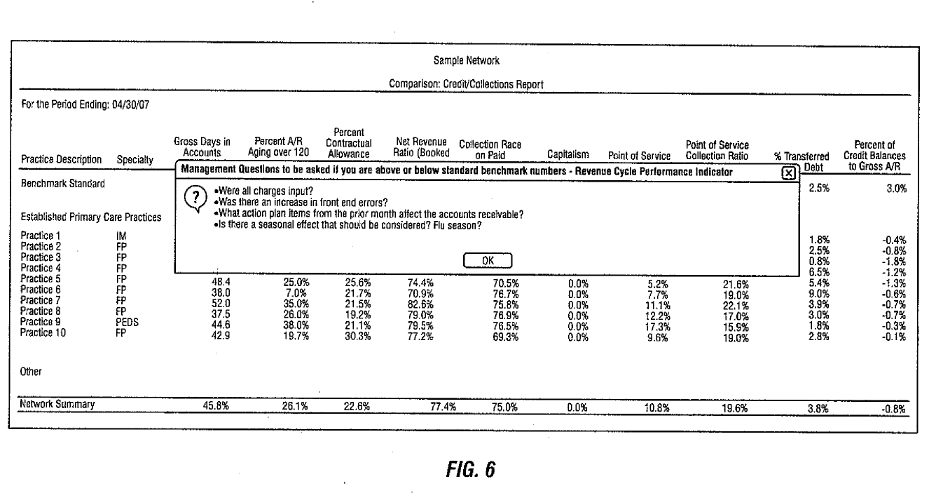

In this example, the decision support tools operate in the context of a revenue cycle performance indicator. In this context, a Network Credit/Collection Report may be generated that measures revenue cycle performance indicators and typically lists each practice individually and by specialty. In some cases, the measured indicators are: gross days in accounts receivable; percent of accounts receivable aging over 120 days; percent contractual allowance to gross accounts receivable; net revenue ratio; collection rate on paid charges; point of service collection ratio; percent of accounts receivable transferred to bad debt; percent of credit balance to gross accounts receivable. In this example, each indicator may be given a section titled Corrective Action Plan that is used for management and leadership to record and monitor the plans and actions that will enhance the accounts receivable performance. The second report, which may be titled Payer Mix Report, captures two key indicators, again typically listing each practice individually and by specialty and listing each payer as a percent of the total payer mix. Below are example questions that may be asked by the decision support tools for these types of reports. FIG. 6 is an example screen that could be associated with the decision support tools in this context.
Did the payer mix changes?
Were all charges inputted?
Was there an increase in front end errors?
What action plan items from the prior month affect the accounts receivable?
Is there a seasonal effect that should be considered? Flu season?
Is this a new plan year for payers?
Have all provider participation plans been completed? New provider? Recredentialing?
Is there a portion of the accounts receivable that was written off due to a provider not being recognized by a particular payer?
What charges are consistently being denied by the payer?
Are codes routinely being down coded by the provider or payer?
Are payments being decreased due to the lack of modifiers?
Is the practice consistently asking for payment?
How many payment plans were implemented this month?
Has there been a “clean sweep” balance write-off?
What type of meetings has been conducted with the billing office? Was there a positive outcome yielding a joint action plan? If so, what are the details of the plan and how soon will the practice realize positive accounts receivable performance?

### EXAMPLE 4

### Fee Analyzer

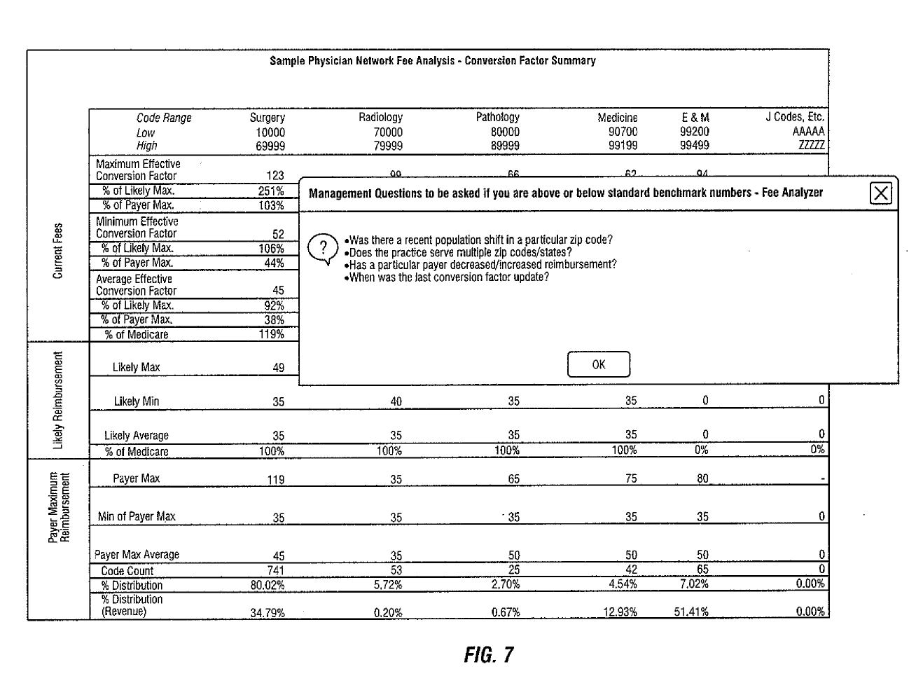

In this example, a fee analyzer may use the RBRVS Relative Value Scale (“RVU's”) for determining the resources used for all Current Procedural Codes (“CPT codes”). CPT codes are a numerical depiction of the work performed by a medical service provider. The RBRVS is composed of three primary components which vary based on the procedure performed and the CPT code utilized. The sum of the three RVU's yields a Total Relative Value. The three primary components that yield the Total Relative Value Unit are: Practice Expense Relative Value Unit; Malpractice Relative Value Unit; and the Work Relative Value Unit. These RVU's, when multiplied by a conversion factor, will result in a fee for the particular CPT code/procedure. This allows for all procedures to be priced according to their complexity. By utilizing the fee analyzer, fees can be easily adjusted as payer reimbursement increases or decreases. Example questions that the decision support tools may ask in the context of the fee analyzer are listed below. FIG. 7 shows an example screen that may be associated with the decision support tool in this context.
Did the payer mix change?
Was there a recent population shift in a particular zip code?
Does the practice serve multiple zip codes/states?
Has a particular payer decreased/increased reimbursement?
When was the last conversion factor update?
Did the last fee schedule change result in increased contractual allowances/write-offs rather than net revenue?
Are there any fees where reimbursement is equal to the fee?
Are there any practices that routinely override the established fee?

Although the present disclosure has been described with reference to particular means, materials, and embodiments, from the foregoing description one skilled in the art can easily ascertain the essential characteristics of the invention and various changes and modifications may be made to adapt the various uses and characteristics without departing from the spirit and scope of the invention.

What is claimed is:

1. A computerized financial management system for physician practices, the system comprising:
a computing device configured to generate a request for a plurality of parameters indicative of a physician practices' financial condition;
an application server operable to receive the request from the computing device via a communications network and send a response that comprises the parameters requested by the computing device and an identification of one or more missed parameters that fall outside a predetermined benchmark;
wherein the computing device is configured to query the application server for at least one possible reason why one or more of the missed parameters fell outside the predetermined benchmark; and
wherein the application server is configured to receive the query and send a response that includes one or more possible causes why the missed parameters fell outside the predetermined benchmark.

2. The system of claim 1, wherein the computing device is configured to generate a request for one or more of a monthly report, a year-to-date report, a benchmark report, a financial ratio report, a revenue cycle report, a CPT coding report, and a fee analyzer report.

3. The system of claim 1, wherein the application server is configured to include possible corrective action to be taken to correct one or more missed parameters.

4. The system of claim 1, wherein the application server includes a plurality of parameters indicative of a physician practices' financial condition that can be reported to the computing device that has a predetermined range of acceptable values, and wherein substantially each of the parameters are associated with one or more predetermined possible reasons why a respective parameter is outside the range of acceptable values.

5. The system of claim 1, wherein the application server is configured to provide response to a request from the computing device regarding revenue generated by physician practices.

6. The system of claim 5, wherein the application server is configured to provide one or more reasons why one or more of the following parameters concerning revenue were outside the benchmark: gross fee for services, contractual allowances, charity allowances, and total net revenue.

7. The system of claim 1, wherein the application server is configured to provide response to a request from the computing device regarding expenses incurred by physician practices.

8. The system of claim 7, wherein the application server is configured to provide one or more reasons why one or more of the following parameters concerning expenses were outside the benchmark: physician compensation and benefits, midlevel compensation and benefits, staff compensation and benefits, building occupancy, clinical supplies, purchased services, equipment, telephone, insurance, and bad debt.

9. The system of claim 1, wherein the application server is configured to provide response to a request from the computing device regarding workload indicators for the physician practices.

10. The system of claim 9, wherein the application server is configured to provide one or more reasons why one or more of the following parameters concerning workload indicators were outside the benchmark: new patient visits, ambulatory visits, hospital visits, total visits, work RVU's, and coding index.

11. The system of claim 1, wherein the application server is configured to provide response to a request from the computing device regarding medical coding practices for the physician practices.

12. The system of claim 11, wherein the application server is configured to provide one or more reasons why coding practices were outside the benchmark.

13. The system of claim 1, wherein the application server is configured to provide a collection report in response to a request from the computing device, wherein the collection report includes a measurement of revenue cycle performance indicators.

14. The system of claim 13, wherein the collection report is categorized by at least one of a practice or by specialty.

15. The system of claim 1, wherein the application server is configured to provide a fee analysis based on CPT codes in response to a request from the computing device, wherein the application server is configured to provide one or more reasons why a parameter of the fee analysis was outside a predetermined benchmark.

16. A computerized method for financial management of a physician's practice, the method comprising the steps of:
presenting a computerized analysis tool configured to report one or more parameters regarding financial management of physician practices;
receiving a request for a financial report or financial analysis;
determining whether any parameters in the financial report or financial analysis are outside a predetermined benchmark;
receiving a request for guidance regarding a parameter that is outside the benchmark; and
automatically generating one or more possible causes for missing the benchmark.

17. A system for financial management of a physicians' practice, the system comprising:
a financial reporting/analysis module configured to provide a plurality of parameters in at least one of a financial report and financial analysis of a physician's practice, wherein at least one parameter is outside a benchmark; and
one or more decision support tools configured to generate possible causes why the parameter is outside the benchmark.

18. The system of claim 17, wherein the decision support tools are configured to generate possible causes why a parameter in one or more of a monthly report, a year-to-date report, a benchmark report, a financial ratio report, a revenue cycle report, a CPT coding report, and a fee analyzer report is outside a predetermined benchmark.

19. The system of claim 18, wherein the decision support tools are configured to include possible corrective action to be taken to correct one or more parameters that are outside the predetermined benchmark.
